(19) United States
(12) Patent Application Publication
(10) Pub. No.: US 2009/0211856 A1
(43) Pub. Date: Aug. 27, 2009

(54) PERFORMANCE DISC BRAKE SYSTEM

(76) Inventor: Robert Sollenskog, Indianapolis, IN (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/035,528

(22) Filed: Feb. 22, 2008

(51) Int. Cl. B60T 1/06; F16D 65/00; F16D 63/00; G05D 23/00

(52) U.S. Cl. 188/18 A; 188/73.1; 188/68; 700/300

(57) ABSTRACT

A disc brake mechanism including a generally annular rotor ring having an outer diameter and an inner diameter, a plurality of teeth extending from the inner diameter of the rotor ring, a generally cylindrical drive shaft head defining a major axis, and a plurality of rounded connection wedges extending therefrom. A pair of brake pads are disposed on opposite sides of the rotor, a caliper is connected to a non-rotating portion of a vehicle, a piston is operationally connected to the caliper and disposed adjacent a brake pad, and a pressure plate is operationally connected adjacent a brake pad and positioned opposite the rotor from the piston. Force members are operationally connected to the brake pads. The plurality of rounded connection wedges defines a generally frusto-spherical shape and further defines a plurality of teeth-engaging slots, while each respective slot is shaped to engage a respective tooth, the force members urge the brake pads away from the rotor ring, and the rotor ring is able to pivot at least about 3 degrees about a point on the major axis.

### TECHNICAL FIELD

The present novel technology relates generally to the field of automotive engineering and, more particularly, to a full contact disc brake system.

### BACKGROUND

Full disc or full annular disc brakes are not new and are attractive for the obvious advantages of having a complete annular array of friction pads contacting an annular rotor disc on both sides thereof. Braking is essentially a transduction of vehicular kinetic energy into thermal energy. Braking is thus limited by the contact area of the interface between the stationary or non-rotating friction members (brake pads) and the rotating member (rotor) connected to the drive member of the vehicle. Braking efficiency is also a function of how fast the heat generated from this transduction process may be removed from the brake pads and rotor. In a full annular brake there is a large area to distribute the braking energy more efficiently, but at the expense of surface available for air cooling.

One of the main problems is adapting the technology of a full annular brake system is overheating. Another tissue is performance. When braking events occur more quickly and efficiently, there is a corresponding reduction of time for control events to occur.

There thus remains a need for a more efficient braking system with improved performance and handling characteristics. The present novel technology addresses this need.

### SUMMARY

The present novel technology relates to disc brake system wherein the disc is contacted over most of its face by disc-shaped brake pads, instead of over just a portion of its face as in traditional systems. In one embodiment, the system is further distinguished in that the pressure vessel is inverted to decrease the piston surface area. The caliper and piston portions are arranged such that the piston protrudes from the caliper, with the square seals located in the caliper. Push-back is provided by a set of compression springs oriented around the fastening bolts.

In other embodiments, the brake rotor internal drive geometry is improved such that instead of a simple hexagonal geometry, the rotor has a best characterized as a hexagon with a wedge formed into each face of the hexagon, the wedge receiving a corresponding raised rib portion of the rotor drive member.

One object of the present novel technology is to provide an improved disc brake system. Related objects and advantages of the present novel technology will be apparent from the following description.

### BRIEF DESCRIPTION OF THE DRAWINGS

FIG. 1A is a perspective view of a first embodiment disc brake assembly according to the present novel technology.

FIG. 1B is a first axial cross sectional view of the disc brake assembly of FIG. 1A.

FIG. 1C is a second axial cross sectional view of FIG. 1A, rotated 90 degrees relative to the view of FIG. 1B.

FIG. 2 is an exploded perspective view of FIG. 1A.

FIG. 3A is a front plan view of a first caliper and piston combination of FIG. 2.

FIG. 3B is a side elevational view of FIG. 3A.

FIG. 3C is a perspective view of FIG. 3A.

FIG. 3D is a front plan view of a second caliper and piston combination of FIG. 2.

FIG. 3E is a side elevational view of FIG. 3D.

FIG. 3F is a perspective view of FIG. 3D.

FIG. 3G is a front plan view of a third caliper and piston combination of FIG. 2.

FIG. 3H is a side elevational view of FIG. 3G.

FIG. 3I is a perspective view of FIG. 3G.

FIG. 3J is a front plan view of a fourth caliper and piston combination of FIG. 2.

FIG. 3K is a side elevational view of FIG. 3J.

FIG. 3L is a perspective view of FIG. 3J.

FIG. 4A is a front plan view of the brake pad assembly of FIG. 2

FIG. 4B is a rear plan view of FIG. 4A.

FIG. 4C is a side elevational view of FIG. 4A.

FIG. 5A is a front plan view of the rotor of FIG. 2.

FIG. 5B is a rear plan view of FIG. 5A.

FIG. 5C is a side elevational view of FIG. 5A.

FIG. 6A is a side elevational view of the drive shaft head of FIG. 1A.

FIG. 6B is a front plan view of FIG. 6A.

FIG. 6C is a perspective view of FIG. 6A.

FIG. 7A is a front plan view of the pressure plate of FIG. 2.

FIG. 7B is a rear plan view of FIG. 7A.

FIG. 7C is a side elevational view of FIG. 7A.

FIG. 8A is a side elevational view of the rotor of FIG. 2 as engaged to the drive shaft head of FIG. 2.

FIG. 8B is a front plan view of FIG. 8A.

FIG. 8C is a perspective view of FIG. 8A.

FIG. 9 is an exploded perspective view of a second embodiment disc brake assembly according to the present novel technology.

FIG. 10 is a perspective view of the embodiment of FIG. 9.

FIG. 11A is a side elevation view of FIG. 10.

FIG. 11B is a sectional view of FIG. 11A.

FIG. 11C is a front plan view of FIG. 10.

FIG. 12A is a side elevation view of FIG. 10 showing the rotor drive titled with respect to the rotor.

FIG. 12B is a sectional view of FIG. 12A.

FIG. 13A is a front plan view of the brake pad assembly of FIG. 9.

FIG. 13B is a side elevational view of FIG. 13A.

FIG. 14A is a front plan view of a first caliper and piston combination of FIG. 9.

FIG. 14B is a side elevational view of FIG. 14A.

FIG. 14C is a perspective view of FIG. 14A.

FIG. 14D is a front plan view of a second caliper and piston combination of FIG. 2.

FIG. 14E is a side elevational view of FIG. 14D.

FIG. 14F is a perspective view of FIG. 14D.

FIG. 15A is a perspective view of the rotor of FIG. 9.

FIG. 15B is a front plan view of FIG. 15A.

FIG. 15C is a side elevational view of FIG. 15A.

FIG. 16A is a side elevational view of the drive shaft head of FIG. 9.

FIG. 16B is a front plan view of FIG. 16A.

FIG. 16C is a perspective view of FIG. 16A.

FIG. 17A is a side elevational view of the rotor of FIG. 9 as engaged to the drive shaft head of FIG. 9.

FIG. 17B is a front plan view of FIG. 17A.

FIG. 17C is a perspective view of FIG. 17A.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

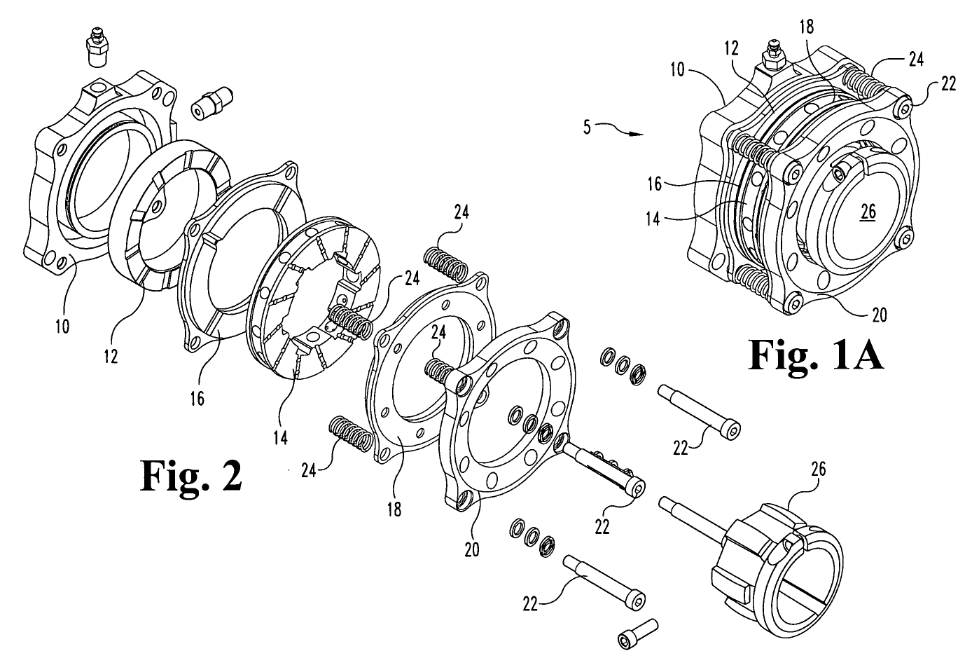

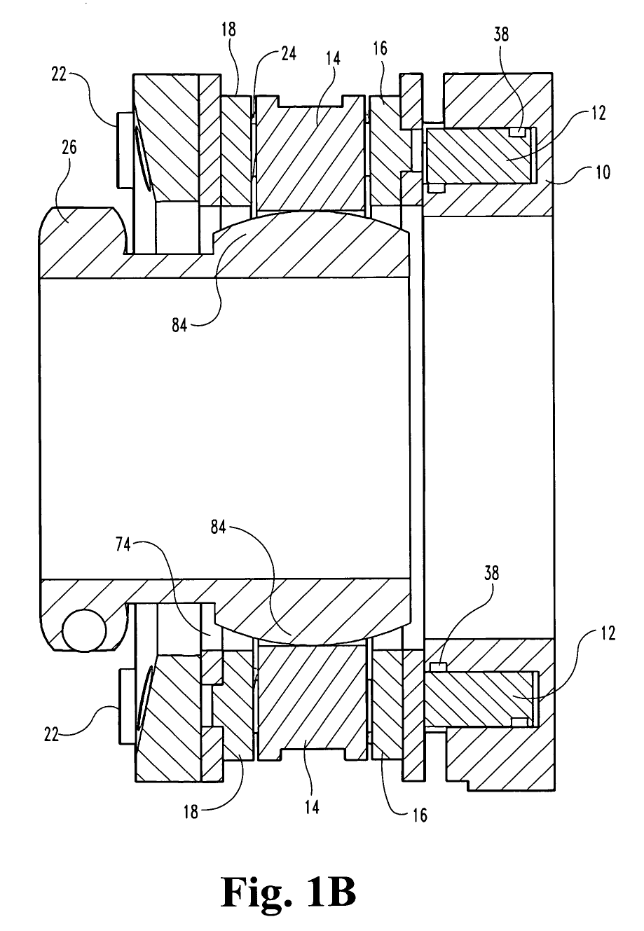

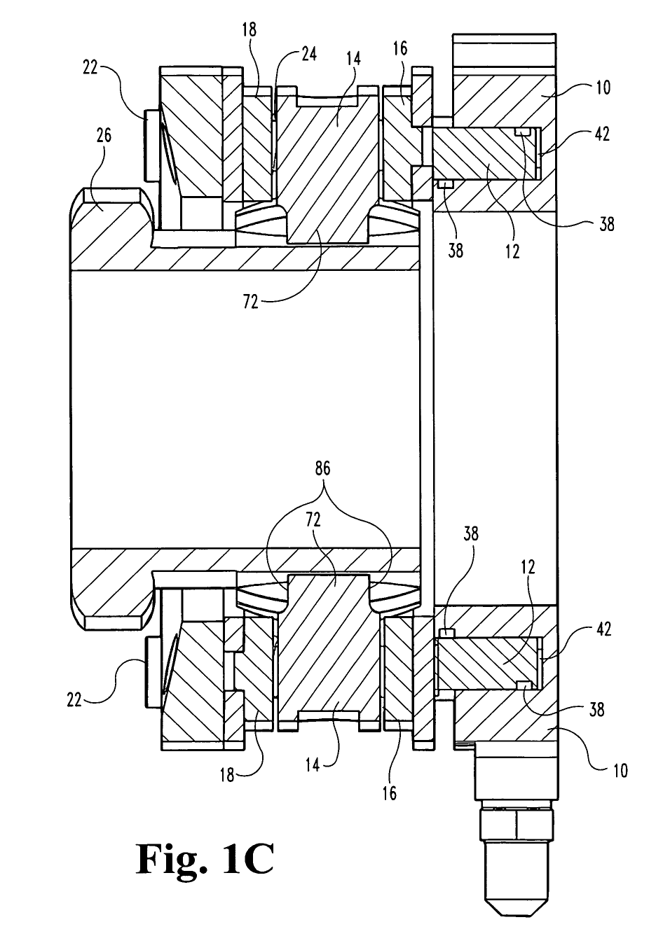

FIGS. 1A-8C illustrates a first embodiment disc brake assembly 5 of the present novel technology. The disc brake assembly 5 includes a caliper 10 that may be connected to a non-rotating portion of a vehicle, such as an automobile or racing kart. The caliper 10 is configured to accept a generally annular piston ring 12. The assembly 5 further includes a rotor 14 and two oppositely disposed brake pads 16, 18, with one pad 16 positioned adjacent the piston 12 and the other pad 18 positioned between the rotor 14 and a pressure plate 20. The caliper 10, piston 12, rotor 14, pads 16, 18 and the pressure plate 20 are held together by a plurality of connection members 22. Urging members 24 are positioned between the pressure pads 16, 18 to provide an urging force on each pad 16, 18 to urge them away from the rotor 14. The rotor 14 is lockingly engaged to drive shaft head 26, which is in turn connected to a vehicular drive shaft (not shown).

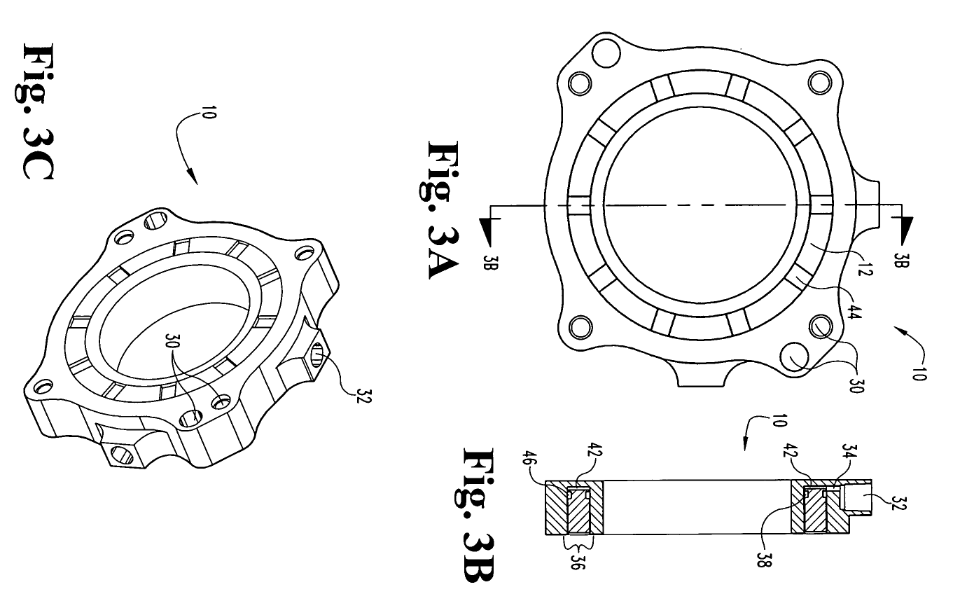

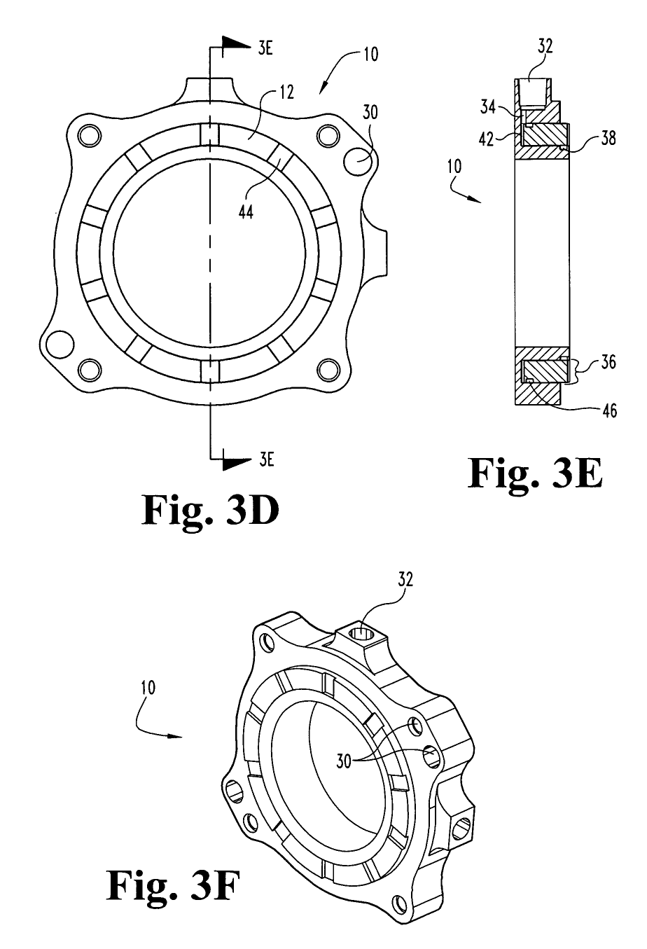

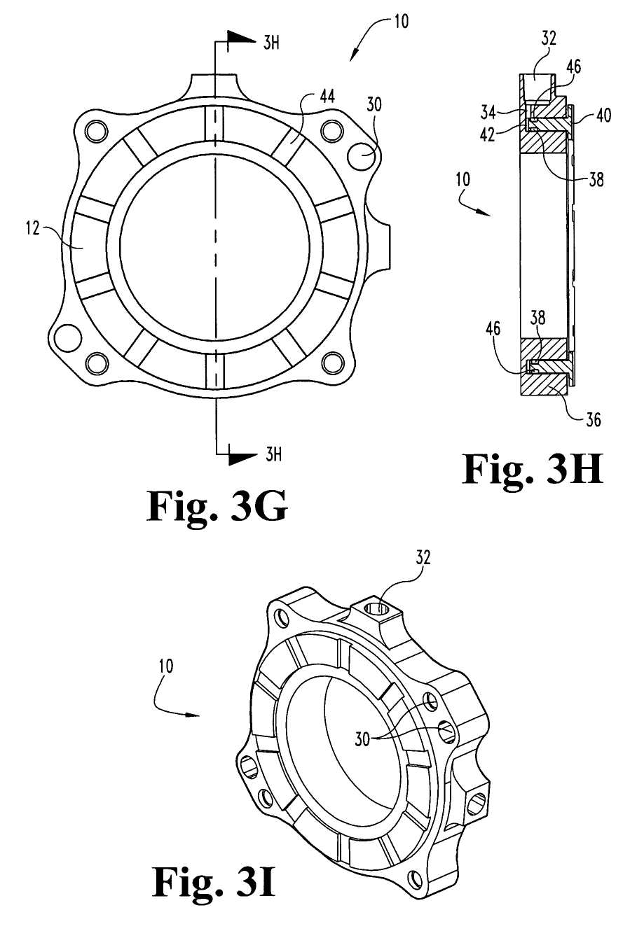

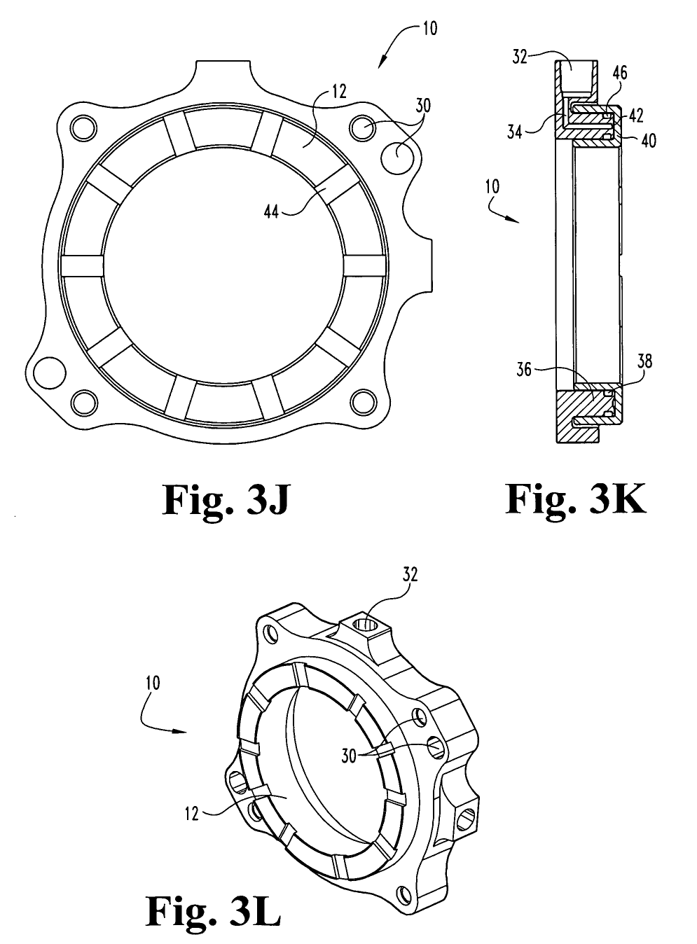

Various caliper 10 and piston 12 configurations are illustrated in greater detail in FIGS. 3A-3L. Referring to FIGS. 3A-3C, caliper 10 includes a plurality of connection apertures 30 for receiving connection members 22. The caliper further includes a fluid port for communicating fluid, such as hydraulic fluid, thereinto through fluid conduit 34. Fluid conduit 34 opens into piston receiving channel or ring 36 formed into the caliper 12. The piston 12 may be received in the channel 36, and when seated in the channel 36 the piston 12 sits substantially flush with the caliper 10. Piston 12 includes at least one, and more typically two, seals 46 connected thereto. In this embodiment, a pair of seals 38, 46 are connected to the piston ring 12 and positioned opposite one another. In other words, the seals 38, 46 are partially seated in grooves formed in the outer diameter (seal 46) and inner diameter (seal 38) walls of the piston ring 12 directly across from each other. When piston 12 is received in receiving channel, a pressure vessel 42 is thus defined. The piston 12 further typically includes a plurality of air conduction or ventilation slots 44 formed thereon.

Another embodiment caliper 10 and piston 12 configuration is illustrated in FIGS. 3D-3F. This embodiment is similar to that of FIGS. 3A-3C, except that that the seals 46 are not positioned directly opposite one another, and that a first seal 46 is connected to the outer diameter of the piston ring 12 while the second seal 46 is connected to the inner diameter of the receiving channel 36 formed in the caliper 10.

Likewise, still another embodiment caliper 10 and piston 12 configuration is illustrated in FIGS. 3G-3I, again similar to the embodiment of FIGS. 3A-3C, with the exception that the piston 12, when seated in the receiving groove 36, extends beyond the caliper 10.

Yet another embodiment caliper 10 and piston 12 configuration is illustrated as FIGS. 3J-3L. This configuration is again similar to that of FIGS. 3A-3C, except in this configuration, receiving channel 36 is formed in the piston 12 and caliper 10 includes a raised inner engaging ring portion 40. Seals 46 are seated into opposite walls of the engaging ring portion 40.

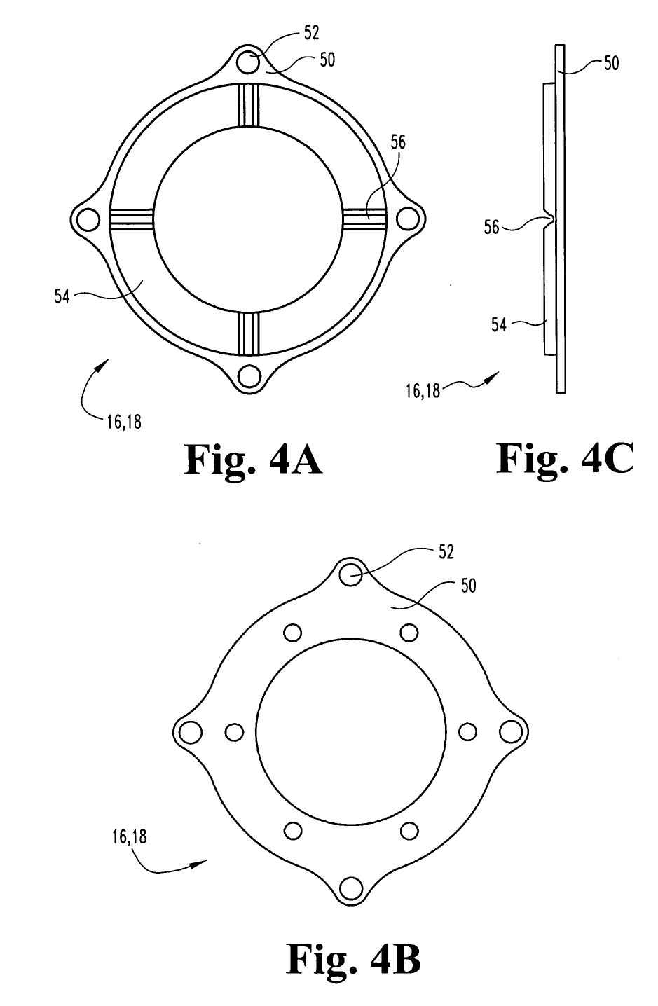

Referring to FIGS. 4A-4C, brake pad 16 is shown in further detail. Brake pad 16 includes a (typically metal) backing plate 50 having a plurality of connection apertures 52 formed therethrough. A layer of ablative friction material 54 is operationally connected to the backing plate 50. Typically, a plurality of ventilation channels 56 are formed at regular intervals in the ablative friction material 54. More typically, the friction material 54 is in the general shape of a ring with the channels 56 running from the outer diameter to the inner diameter of the ring to facilitate thermal communication therebetween.

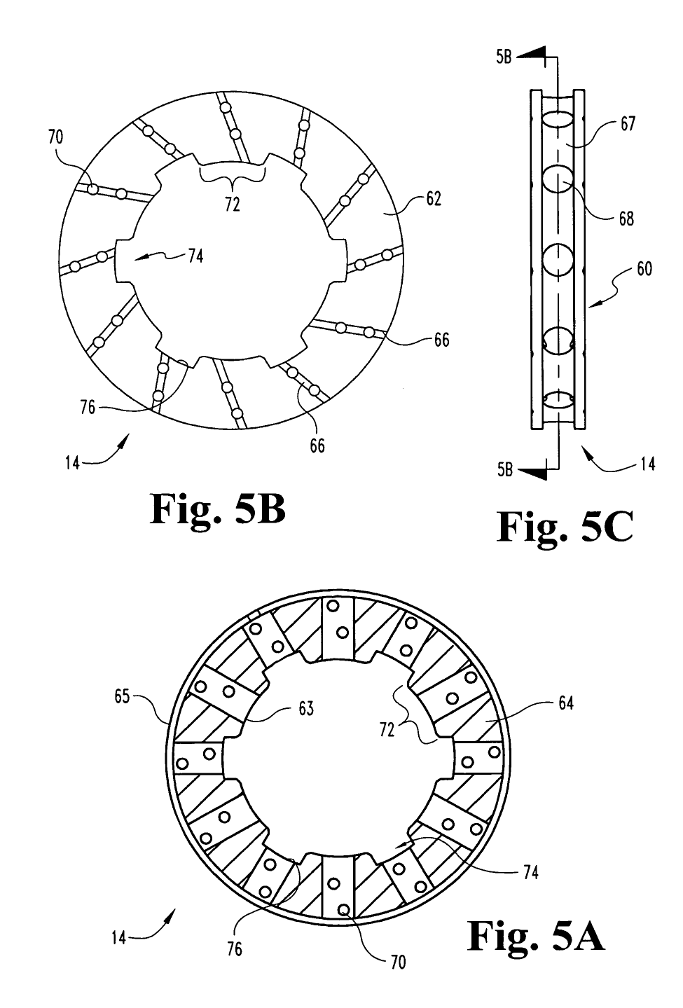

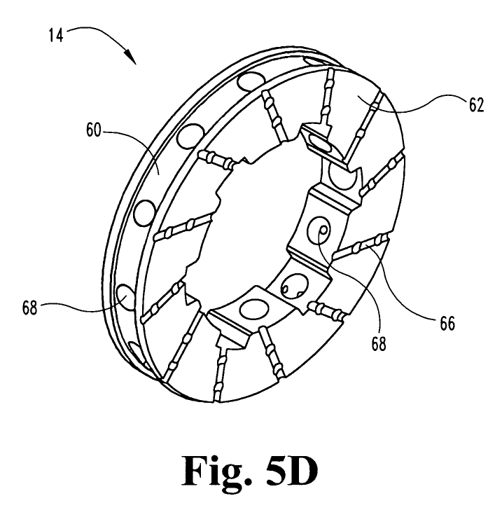

Referring to FIGS. 5A-5C, the rotor 14 is shown in detail. The rotor 14 includes a disc body 60 defining a rotor inner diameter 63 and a rotor outer diameter 65 and also having an anterior face 62 and a posterior face 64. A plurality of anterior face slots 66 are typically formed in the anterior face 62 and extend outwardly from the rotor inner diameter 63 to the rotor outer diameter 65. The rotor 14 further includes a disc edge ring 67 positioned between the faces 62, 64, and typically includes a plurality of ventilation ports 68 formed therethrough. A plurality of ventilation openings or apertures 0 are typically also formed in at least one of the faces 62, 64, and are more typically formed through the slots 66. The inner diameter 63 is generally circular, but typically includes a plurality of drive shaft head-engaging teeth 72 extending therefrom. The teeth 72 further define recesses 74 formed therebetween. The recesses 74 intersect the inner diameter 63 to define recess walls 76.

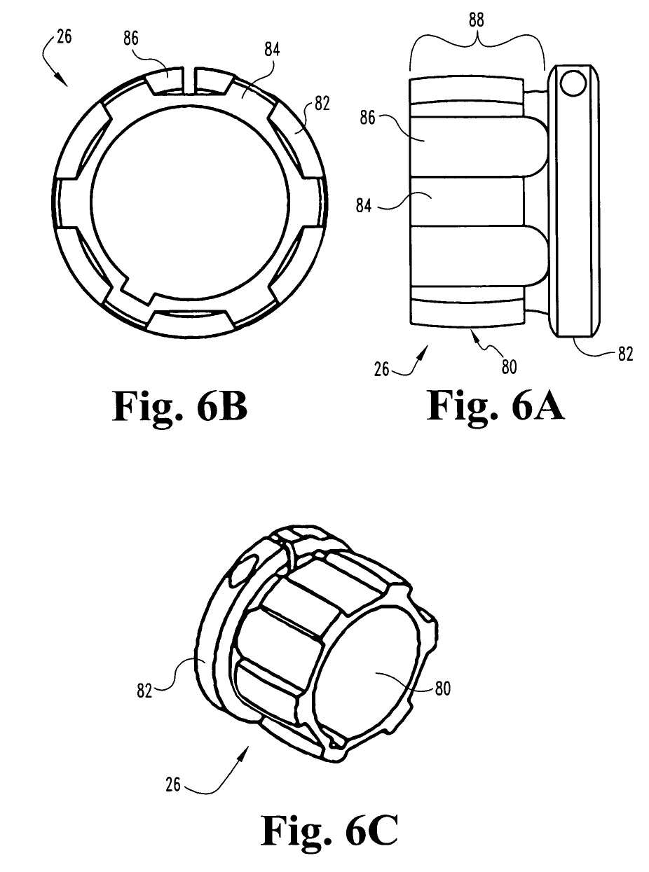

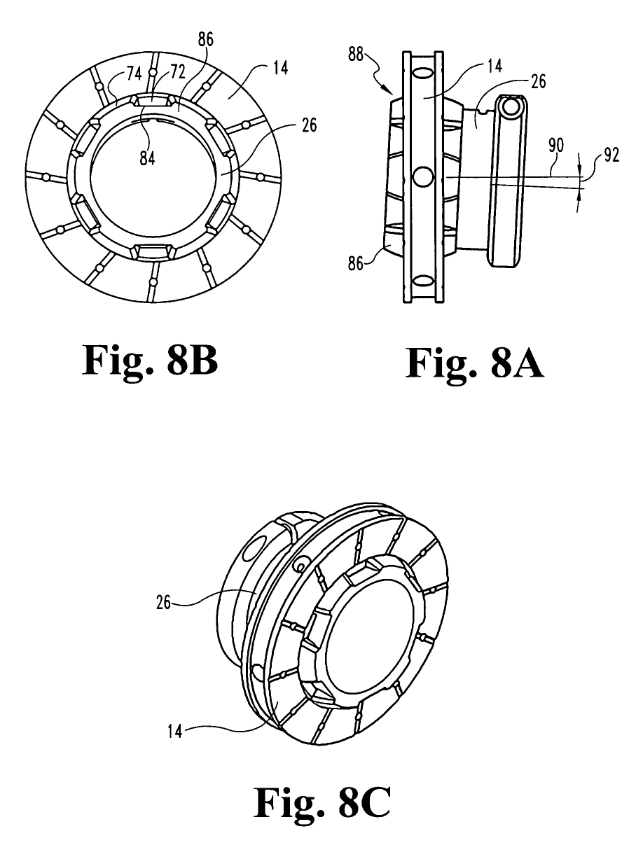

As seen in greater detail in FIGS. 6A-6C, the rotor-engaging drive shaft head 26 is illustrated in greater detail. The head 26 includes a rotor engaging portion 80 connected to a drive shaft engaging portion 82. Typically, the rotor-engaging portion 80 is a generally cylindrical tube operationally connected to the generally cylindrical ring of the drive shaft-engaging portion 82. A plurality of typically evenly-spaced rotor-engaging teeth 84 typically extend from the rotor-engaging portion 80, with each tooth 84 typically sized and shaped to lockingly engage a respective recess 74. Likewise, a plurality of rotor tooth-engaging recesses 86 are defined by the plurality of teeth 84 which are typically sized and shaped to lockingly engage the rotor teeth 72. More typically, the plurality of teeth 84 are contoured to define a curved exterior surface 88 that may more typically be described as generally frusto-spherical or frusto-ovoid. As seen in FIGS. 8A-8C, by defining such a curved connection surface, the interlocking rotor and drive head members 14, 26 may be rotated together about a major axis (such as the axis defined by the drive shaft) with little play, while the plane of rotation of the rotor 14 may be pivoted or tilted through an arc defined by the curvature of the curved connection surface 88. Typically, the plane of rotation of the rotor 14 may be pivoted through an angle of at least about 3 degrees about a point on the major axis and the angle lying in a plane containing the major axis of rotation.

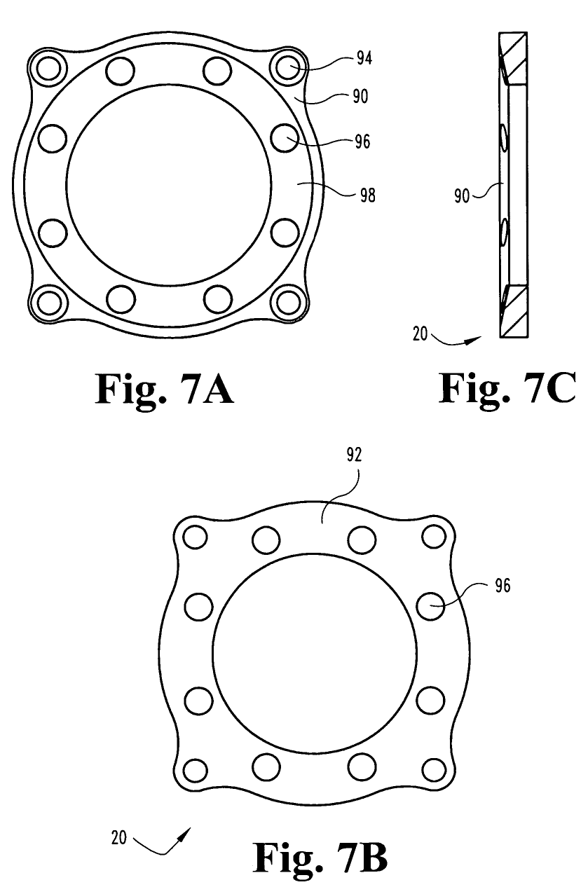

FIGS. 7A-7C illustrates the pressure plate 20 in detail. The pressure plate 20 includes an anterior face 90 and a posterior face 92, with a plurality of connection or fastener apertures 94 formed therethrough. Typically, a plurality of (typically regularly positioned) recesses 96 are formed in one or both faces 90, 92. More typically, the recesses 96 extend completely through the faces 92, 94 as apertures. More typically, the anterior face 90 includes at least a portion 98 curved generally inwardly toward the center or having a generally concave shape.

The caliper 10, piston 12, posterior brake pad 16, rotor 14, anterior brake pad 18 and pressure plate 20 are held together by fasteners 22 that extend through the various connection apertures 30, 52, 94. Further, fasteners 22 engage biasing members 24 to position biasing members 24 between the posterior and anterior brake pads 16, 18. Biasing members 24 thus exert a biasing force on the brake pads 16, 18, urging them away from rotor 14.

In one embodiment, the piston 12 (and, accordingly, the pressure vessel 42) is inverted with respect to the caliper 10, such that the surface area of the piston 12 in the pressure vessel 42 is decreased.

In operations, hydraulic fluid or the like is introduced through fluid port 30 and fluid conduit 34 into pressure vessel 42. As the fluid flows into pressure vessel 42, piston 12 is urged away from caliper 10 to increase the volume of the pressure vessel 42. Movement of the piston 12 away from the caliper 10 urges the brake pads 16, 18 into contact with the rotor 14. Typically, each respective brake pad 16, 18 includes sufficient ablative friction material 54 to engage at least about 70 percent of the respective rotor face 62, 64; more typically, each respective brake pad 16, 18 includes sufficient ablative friction material 54 to engage at least about 85 percent of the respective rotor face 62, 64. During braking, kinetic energy is transduced to thermal energy, heating the assembly 5; at the same time, air flows through or radiates from vent ports and channels 44, 56, 68, 70, 96 to cool the assembly 5.

After a braking event, the brake pads 16, 18 are urged away from the rotor 14 via an urging force generated by the urging members or springs 24 operationally connected to the fastener bolts 22 and positioned between the pads 16, 18. Since braking moves the pads 16, 18 closer together, the springs 24 are thus compressed and contain stored energy; once the braking event is over and the piston 12 is no longer exerting a compressive force on the pads 16, 18 and, accordingly, the springs 24, the springs 24 are free to release the stored energy via an expansion event and thus move the pads 16, 18 further apart from one another and away from the rotor 14. In other words, expansion of the pressure vessel 42 moves the piston 12 away from the caliper 10, generating a compressive force on the springs 24 to urge the pads 16, 18 into contact with the rotor 14. Urging the pads 16, 18 into contact with a turning rotor 14 enables the transduction of kinetic energy into thermal energy, which has a resultant braking effect on a vehicle driven by a drive shaft coupled to the rotor 14. Once the braking event is over or as hydraulic pressure to the pressure vessel 42 is reduced, the springs 24 urge the brake pads 16, 18 away from the rotor 14 to prevent unwanted braking.

During the braking event, increasing the amount of hydraulic pressure applied to the pressure vessel 42 increases the clamping or urging force pushing the pads 16, 18 into the rotor 14 and thus the amount of kinetic energy that may be transduced into thermal energy during a given unit of time. In other words, the harder the pads 16, 18 are forced into the rotor 14, the quicker the kinetic energy of the rotor 14 and drive shaft are reduced and the faster the reduction in vehicular velocity. Further, the positive urging of the pads 16, 18 away from the rotor 14 as soon as the braking event is concluded facilitates cooling air flow through the vent ports and channels 44, 56, 68, 70, 96 to the rotor 14 and brake pads 16, 18.

During braking events occurring while the vehicle is undergoing a sharp turn (such as if the vehicle is a go-kart or the like), the rotor 14 may pivot through an angle 92 of a few degrees relative to the major axis 90 coincident with the drive shaft and drive shaft head 26. More particularly, the rotor disc 14 defines a plane, and the plane of the rotor disc 14 may pivot through an arc 92 of a few degrees about a point on the major axis 90. The angle or arc 92 is confined to a plane containing the major axis 90 and perpendicular to the plane containing the rotor disc 14. Typically, the rotor 14 may pivot through an angle of at least about 3 degrees. Such pivoting increases the handling of the vehicle during sharp turns. For example, if the vehicle is a go-kart, the vehicle may be able to corner sharply while braking with three of four wheels on the ground and the remaining wheel (typically, the innermost or inside rear wheel) off the ground. This enhanced maneuverability is desirable, especially during racing, and also reduces the risk of limiting brake pad 16, 18 to rotor 14 contact or rubbing. Performance is further enhanced by increasing the surface contact area between the rotor 14 and brake pads 16, 18, and/or by increasing the coefficient of friction of the pads 16, 18 relative to that of standard pads. Further, the system 5 typically includes a rotor 14 characterized by a smaller diameter than a standard brake, such that the surface speed of the rotor 14 contact area is slower than that of a standard brake system rotor. By increasing the rotor 14 contact area while decreasing the surface speed, the frictional forces experienced by the brake are minimized, thus enhancing performance.

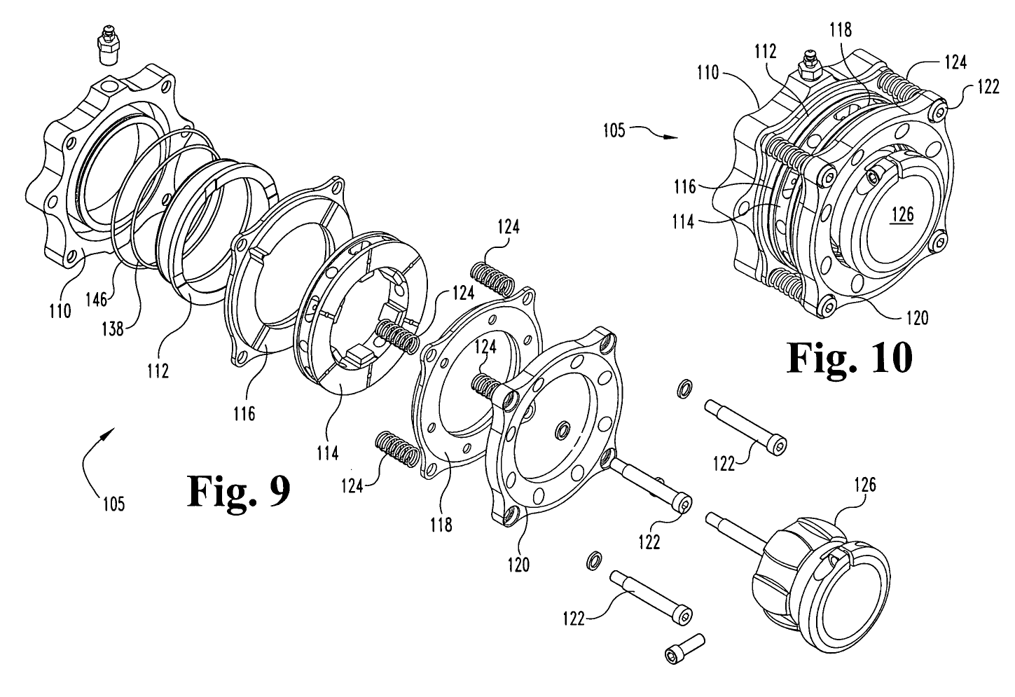

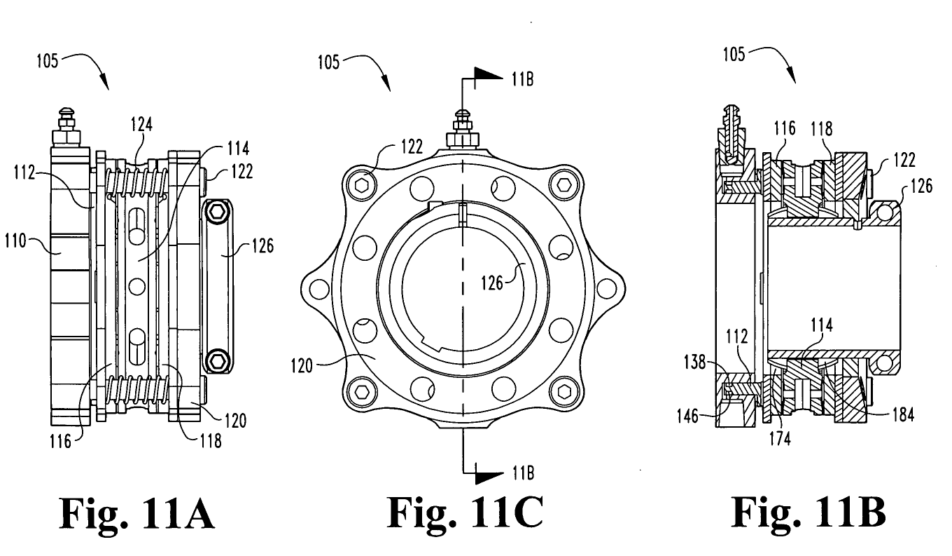

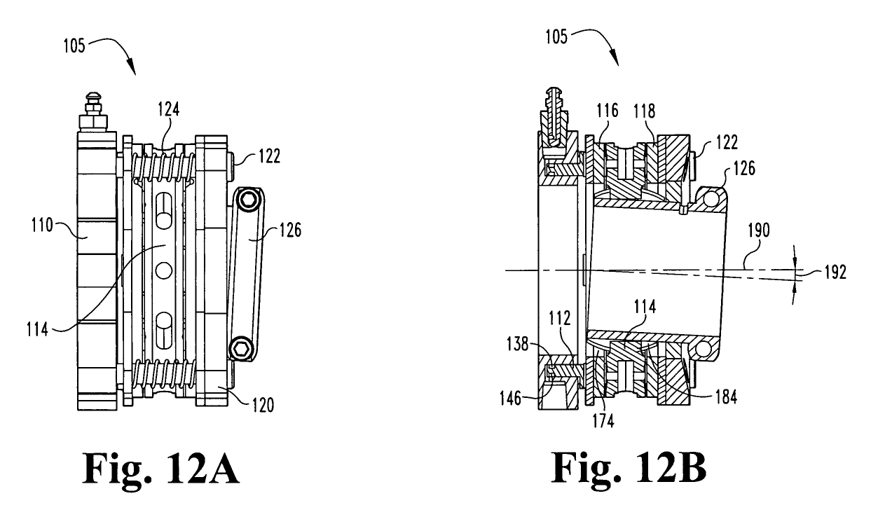

FIGS. 9-17C relate to a second embodiment of the present novel technology, a disc brake assembly 105 similar to the embodiment shown and described above in FIGS. 1-8. Disc brake assembly 105 includes a caliper 110 that connectable to a non-rotating portion of a vehicle. The caliper 110 is configured to engage a generally annular piston ring 112. The assembly 105 further includes a rotor 114 and two oppositely disposed brake pads 116, 118, with one pad 116 positioned adjacent the piston 112 and the other pad 118 positioned between the rotor 114 and a pressure plate 120. The caliper 110, piston 112, rotor 114, pads 116, 118 and pressure plate 120 are fastened by a plurality of connection members 122. Urging members 124 are positioned between the pressure pads 116, 118 to provide an urging force directed away from the rotor 114 on each pad 116, 118. The rotor 114 may be operationally connected to drive shaft head 126, which is in turn connected to a vehicular drive shaft (not shown).

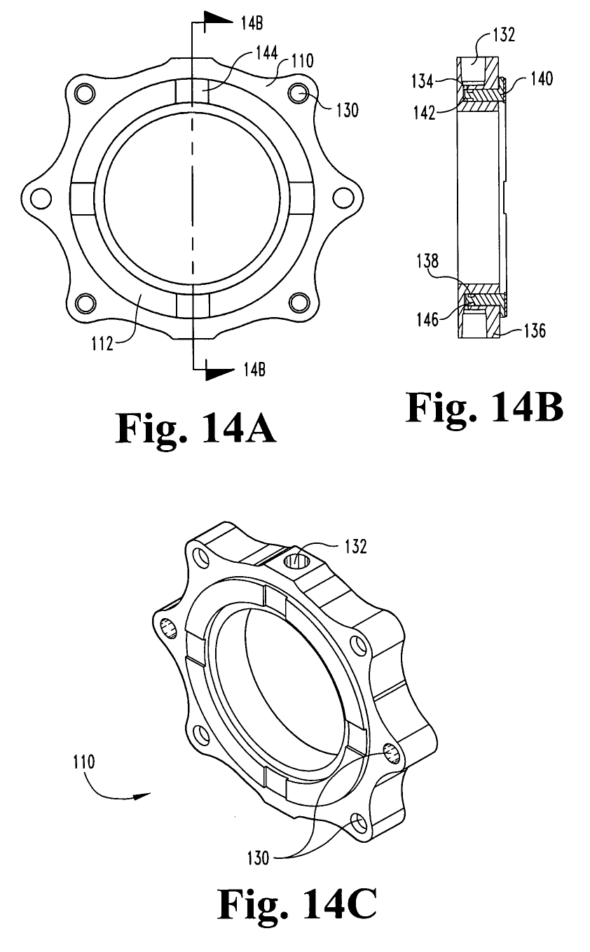

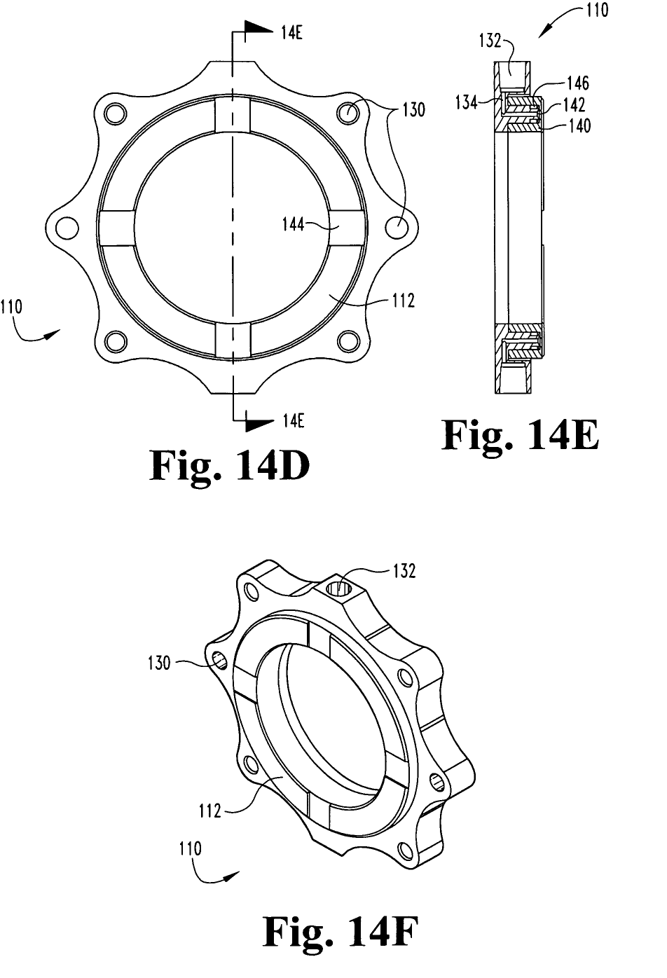

Various caliper 110 and piston 112 configurations are illustrated in greater detail in FIGS. 14A-14F. Referring to FIGS. 14A-14C, caliper 110 includes a plurality of connection apertures 30 for receiving connection members 122. The caliper further includes a fluid port for communicating fluid, such as hydraulic fluid, thereinto through fluid conduit 134. Fluid conduit 134 opens into piston receiving channel or ring 136 formed into the caliper 112. The piston 112 may be received in the channel 136, and when seated in the channel 136 the piston 112 sits substantially flush with the caliper 110. Piston 112 includes at least one, and more typically two, seals 138, 146 connected thereto. As illustrated, inner and outer seals 138, 146 are connected to the piston ring 112 and positioned opposite one another. In other words, the seals 138, 146 are partially seated in grooves formed in the outer diameter (seal 146) and inner diameter (seal 138) walls of the piston ring 112 directly across form each other. When piston 112 is received in receiving channel, a pressure vessel 142 is thus defined. The piston 112 further typically includes a plurality of air conduction or ventilation slots 144 formed thereon. In this configuration, the surface area of the piston 112 is minimized such that less fluid volume is required to move the piston 112 to yield a more favorable balance between brake pedal movement and piston travel.

Another embodiment caliper 110 and piston 112 configuration is illustrated as FIGS. 14D-14F. This configuration is again similar to that of FIGS. 14A-14C, except in this configuration, receiving channel 136 is formed in the piston 112 and caliper 110 includes a raised inner engaging ring portion 140. Seals 146 are seated into opposite walls of the engaging ring portion 140.

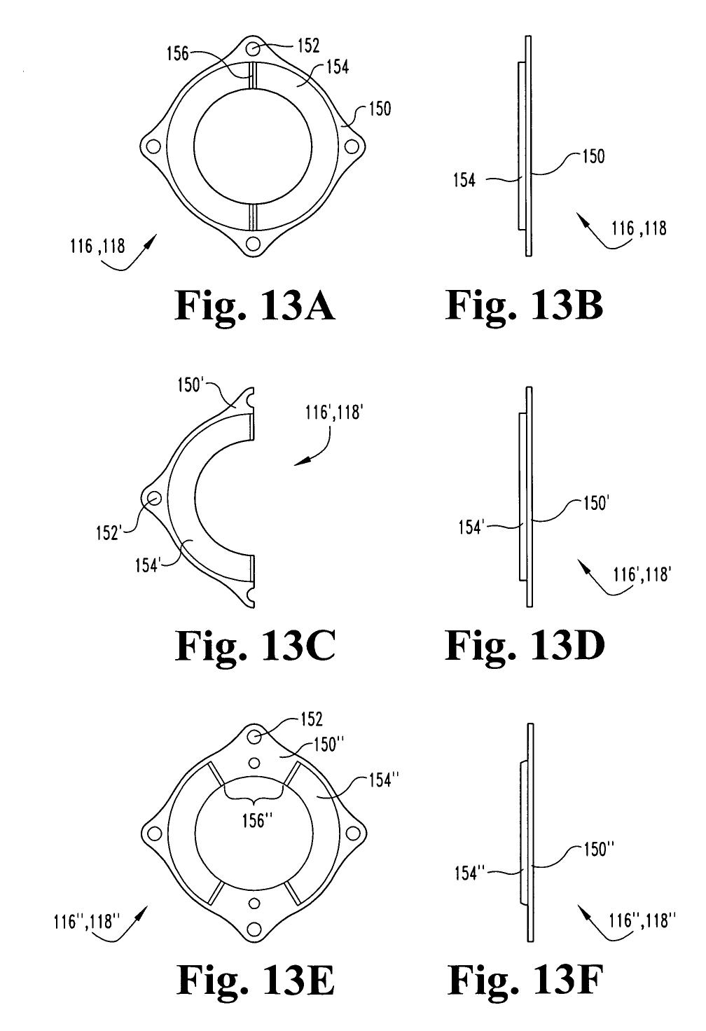

Referring to FIGS. 13A-13B, brake pad 116, 118 is shown in further detail. Brake pad 116, 118 includes a (typically metal) backing plate 150 having a plurality of connection apertures 152 formed therethrough. A layer of ablative friction material 154 is operationally connected to the backing plate 150. Typically, a plurality of ventilation channels 156 are formed at regular intervals in the ablative friction material 154. More typically, the friction material 154 is in the general shape of a ring with the channels 156 running from the outer diameter to the inner diameter of the ring to facilitate thermal communication therebetween.

Referring to FIGS. 13C-13D, bifurcated brake pad 116′, 118′ is shown. Brake pad 116′, 118′ is similar to brake pad 116, 118, except that it is provided as a half-piece; two pads 116′, 118′ may be combined to function as a complete unit, and provision of the unit as two bifurcated pieces 116′, 118′ allows for ease of replacement.

FIGS. 13E-13F illustrate still another brake pad configuration, brake pad 116″, 118″, similar to the design illustrated in FIGS. 13A-13B, but for the area of the channel 156″ being substantially increased as the area of the friction material 154″ is substantially decreased. Pad 116″, 118″ thus generates substantially less friction-generated heat upon use, while the cooling channel 156″ is significantly larger; the combination of these two factors combines to significantly reduce the likelihood of excess heat generation and temperature increase during prolonged braking events.

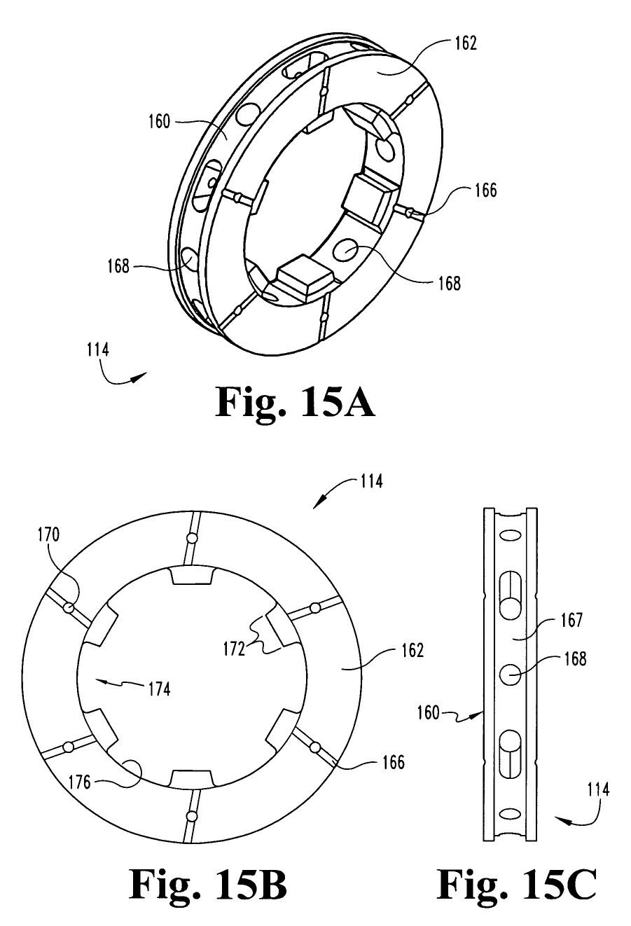

Referring to FIGS. 15A-15C, the rotor 114 is shown in detail. The rotor 114 includes a disc body 160 defining a rotor inner diameter 163 and a rotor outer diameter 165 and also having an anterior face 162 and a posterior face 164. A plurality of anterior face slots 166 are typically formed in the anterior face 162 and extend outwardly from the rotor inner diameter 163 to the rotor outer diameter 165. The rotor 114 further includes a disc edge ring 167 positioned between the faces 162, 164, and typically includes a plurality of ventilation ports 168 formed therethrough. A plurality of ventilation openings or apertures 170 are typically also formed in at least one of the faces 162, 164, and are more typically formed through the slots 166. The inner diameter 163 is generally circular, but typically includes a plurality of drive shaft head-engaging teeth 172 extending therefrom. The teeth 172 further define recesses 174 formed therebetween. The recesses 174 intersect the inner diameter 163 to define recess walls 176.

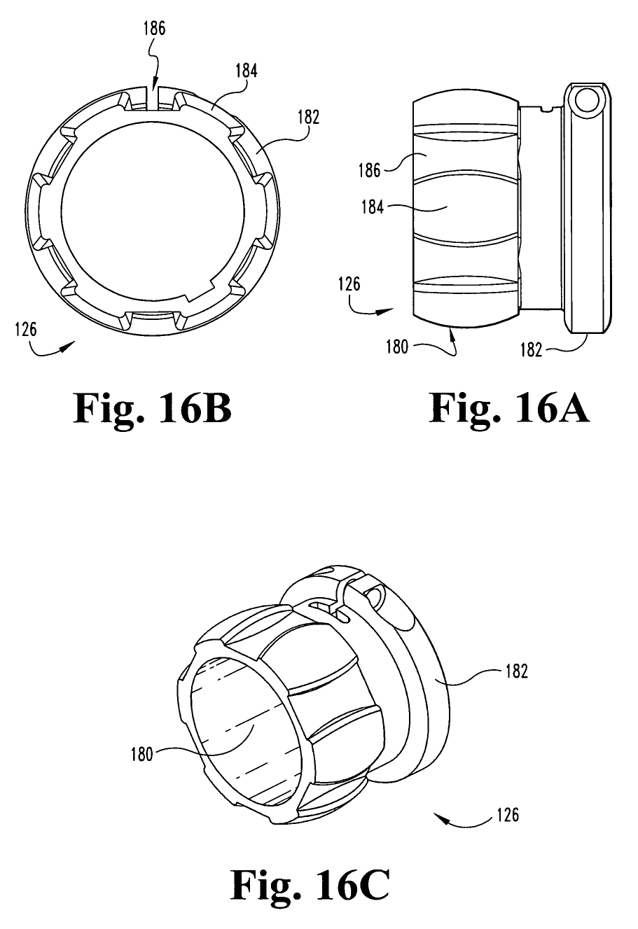

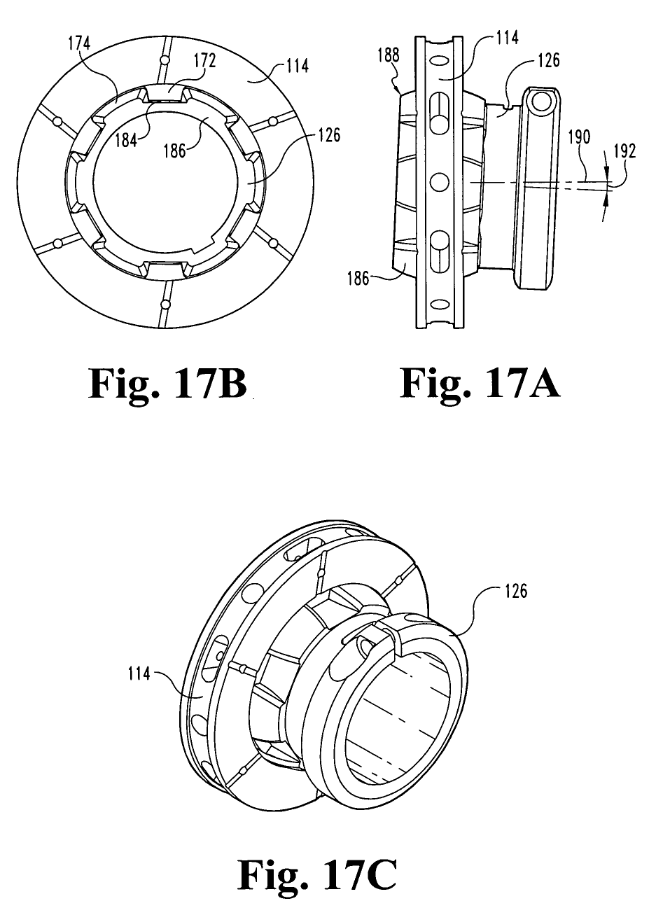

As seen in greater detail in FIGS. 16A-16C, the rotor engaging drive shaft head 126 is illustrated in greater detail. The head 126 includes a rotor engaging portion 180 connected to a drive shaft engaging portion 182. Typically, the rotor-engaging portion 180 is a generally cylindrical tube operationally connected to the generally cylindrical ring of the drive shaft-engaging portion 182. A plurality of typically evenly-spaced rotor-engaging teeth 184 typically extend from the rotor-engaging portion 180, with each tooth 184 typically sized and shaped to lockingly engage a respective recess 174. Likewise, a plurality of rotor tooth-engaging recesses 186 are defined by the plurality of teeth 184 which are typically sized and shaped to lockingly engage the rotor teeth 172. More typically, the plurality of teeth 184 are contoured to define a curved exterior surface 188 that may more typically be described as generally frusto-spherical or frusto-ovoid. As seen in FIGS. 17A-17C, by defining such a curved connection surface, the interlocking rotor and drive head members 114, 126 may be rotated together about a major axis (such as the axis defined by the drive shaft) with little play, while the plane of rotation of the rotor 114 may be pivoted or tilted through an arc defined by the curvature of the curved connection surface 188. Typically, the plane of rotation of the rotor 114 may be pivoted through an angle of at least about 3 degrees about a point on the major axis and the angle lying in a plane containing the major axis of rotation.

The caliper 110, piston 112, posterior brake pad 116, rotor 114, anterior brake pad 118 and pressure plate 120 are held together by fasteners 122 that extend through the various connection apertures 130, 152, 194. Further, fasteners 122 engage biasing members 124 to position biasing members 124 between the posterior and anterior brake pads 116, 118. Biasing members 124 thus exert a biasing force on the brake pads 116, 118, urging them away from rotor 114.

In one embodiment, the piston 112 (and accordingly, the pressure vessel 142) is inverted with respect to the caliper 110, such that the surface area of the piston 112 in the pressure vessel 142 is decreased.

In operation, the system 105 functions much like system 5 described above. By varying the brake pad contact surface area, the performance characteristics, such as stopping power, heat generation, heat dissipation, and the like, can be fine tuned in view of desired performance of the system 105. The friction material 154 may be semi-metallic, ceramic, carbon composite, or the like.

The rotor drive 126 may be made of 4140 chromoly or like material. The caliper 110 may be made of aluminum 6061 or like material. The pressure plate 120 may be made of 303 stainless steel or like material and the piston 112 may be made of 304 stainless steel or like material. The brake rotor 114 may be made of ductile iron, steel, ceramic composites or like material.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A disc brake assembly for a wheel, comprising:
a caliper connected to a non-rotating portion of a vehicle and defining an annular piston channel;
an annular piston at least partially disposed within the annular piston channel;
at least one seal extending between the annular piston channel and the piston;
a pressure vessel defined by the annular piston, the annular piston channel and the at least one seal;
a fluid source in fluidic communication with the pressure vessel;
a rotor drive shaft head having a head inner diameter and a head outer diameter;
a rotor drive shaft defining a major axis and engaged to the head inner diameter;
a rotor defining a rotor contact surface and operationally connected to the rotor drive shaft head;
a first substantially cylindrical brake pad positioned adjacent between the piston and the rotor;
a second substantially cylindrical brake pad positioned adjacent the rotor and disposed opposite the first substantially cylindrical brake pad;
a pressure plate positioned adjacent the second substantially cylindrical brake pad and disposed opposite the rotor; and
at least one spring disposed between the first and second brake pads;
wherein the spring urges the respective brake pads away from the rotor;
wherein the rotor is generally a ring defining a ring inner diameter and a ring outer diameter;
wherein a plurality of teeth extend from the ring inner diameter;
wherein the head outer diameter is shaped to lockingly engage the plurality of teeth; and
wherein once engaged to the rotor drive shaft head, the rotor may pivot at least about 3 degrees about a point on the major axis; and wherein the pivot angle is contained in a plane containing the major axis.

2. The assembly of claim 1 wherein the rotor drive shaft head further comprises an annular ring portion engageable to a rotor drive shaft and a rotor engaging portion extending from the annular ring portion, wherein the rotor engaging portion is defined by a generally convex outer surface further defining a plurality of tooth-engaging slots.

3. The assembly of claim 1 wherein the substantially cylindrical brake pads may be engaged to contact at least about 85 percent of the rotor contact surface.

4. The assembly of claim 1 wherein the substantially cylindrical brake pads may be engaged to contact at least about 70 percent of the rotor contact surface.

5. The assembly of claim 1 wherein the substantially cylindrical brake pads and the rotor include channels formed therein to facilitate air cooling.

6. The assembly of claim 1 wherein the pressure plate includes a plurality of ventilation apertures formed therethrough.

7. A disc brake system, comprising:
a generally annular rotor ring defining an outer ring surface, an inner ring surface, and oppositely disposed first and second ring faces;
a rotatable drive shaft defining a major axis;
a plurality of generally wedge-shaped teeth extending from the inner ring surface;
a plurality of ventilation apertures formed through the rotor ring;
a drive shaft head connected to the drive shaft and further comprising;
a drive shaft-engaging portion; and
a rotor-engaging portion operationally connected to the drive shaft-engaging portion;
wherein the rotor-engaging portion defines a generally frusto-spherical shape and further defines a plurality of slots;
wherein each respective slot is shaped to engage a respective wedge-shaped tooth;
a pair of brake pads disposed adjacent respective first and second rotor ring faces;
a caliper connected to non-rotating portion of a vehicle;
a piston operationally connected to the caliper and disposed adjacent a brake pad;
a pressure plate operationally connected adjacent a brake pad and positioned opposite the rotor from the piston; and
force members operationally connected to the brake pads;
wherein the force members urge the brake pads away from the rotor ring;
wherein the ring is positioned to revolve about the major axis defining a plane of rotation; and
wherein the rotor ring is able to pivot at least about 3 degrees about a point on the major axis in a direction substantially orthogonal to the plane of rotation.

8. The system of claim 7 wherein the piston is inverted.

9. The assembly of claim 7 wherein the brake pads may be engaged to contact at least about 85 percent of the rotor surface.

10. The assembly of claim 7 wherein the brake pads may be engaged to contact at least about 70 percent of the rotor surface.

11. The assembly of claim 7 wherein the brake pads and the pressure plate include channels formed therein to facilitate air cooling.

12. A disc brake mechanism, comprising:
a generally annular rotor ring having an outer diameter and an inner diameter;
a plurality of teeth extending from the inner diameter;
a generally cylindrical drive shaft head defining a major axis and having a plurality of rounded connection wedges extending therefrom;
a pair of brake pads disposed on opposite sides of the rotor;
a caliper connected to a non-rotating portion of a vehicle;
a piston operationally connected to the caliper and disposed adjacent a brake pad;
a pressure plate operationally connected adjacent a brake pad and positioned opposite the rotor from the piston; and
force members operationally connected to the brake pads;
wherein the plurality of rounded connection wedges defines a generally frusto-spherical shape and further defines a plurality of teeth-engaging slots;
wherein each respective slot is shaped to engage a respective tooth;
wherein the force members urge the brake pads away from the rotor ring; and
wherein the rotor ring is able to pivot at least about 3 degrees about a point on the major axis.

13. A disc brake rotor assembly, comprising:
a generally annular rotor ring having an outer diameter and an inner diameter and defining a pair of opposite ring faces;
a plurality of generally wedge-shaped teeth extending from the inner diameter; and
a generally cylindrical drive shaft head defining a major axis and having a plurality of rounded connection wedges extending therefrom;
wherein the plurality of rounded connection wedges defines a plurality of teeth-engaging slots;
wherein each respective slot is shaped to engage a respective generally wedge-shaped tooth; and
wherein the annular rotor ring is able to pivot at least about 3 degrees about the major axis.

14. The assembly of claim 13 wherein the plurality of rounded connection wedges further defines a generally frusto-spherical shape.

15. The assembly of claim 13 wherein the plurality of rounded connection wedges further defines a generally frusto-ovoid shape.

16. The assembly of claim 13 wherein a plurality of ventilation apertures extend from the outer diameter to the inner diameter and wherein a plurality of ventilation grooves are formed in the ring faces.

17. A method of converting vehicular kinetic energy into thermal energy; comprising;
a) operationally connecting a rotor to a vehicular drive shaft;
b) defining a major axis of rotation collinear with the drive shaft;
c) rotating the vehicular drive shaft and rotor as the vehicle moves to define a plane of rotation substantially orthogonal to the major axis of rotation;
d) frictionally engaging at least one brake pad against the rotating rotor; and
e) pivoting the rotor through an art of about 3 degrees relative about a point on the major axis and in a plane containing the major axis of rotation;
wherein the plane containing the major axis is substantially orthogonal to the plane of rotation.

18. The method of claim 17 wherein the a rotor defines an outer diameter and an inner diameter; wherein a plurality of wedge-shaped teeth extend from the inner diameter; wherein a generally cylindrical drive shaft head is connected to the vehicular drive shaft; wherein a plurality of rounded connection wedges extending from the drive shaft head; wherein the plurality of rounded connection wedges defines a generally frusto-spherical shape and further defines a plurality of teeth-engaging slots; wherein each respective slot is shaped to engage a respective wedge-shaped tooth; and wherein the rotor is able to pivot at least about 3 degrees about a point on the major axis.
